(19) United States
(12) Patent Application Publication
(10) Pub. No.: US 2026/0356587 A1
(43) Pub. Date: Nov. 12, 2026

(54) SHUTTLE AND SHELVING SYSTEM

(71) Applicant: advastore SE, Unterwössen (DE)

(72) Inventors: Rupert KOCH, Bayerisch Gmain (DE); Leopold MEIRER, Unterwössen (DE); Maximilian DHOM, Söchtenau (DE)

(73) Assignee: advastore SE, Unterwössen (DE)

(21) Appl. No.: 19/102,074

(22) PCT Filed: Aug. 9, 2023
(86) PCT No.: PCT/EP2023/072064

§ 371 Date: Feb. 7, 2025

(30) Foreign Application Priority Data
Aug. 11, 2022 (DE) 10 2022 002 935.9

(51) Int. Cl. B65G 1/06; B61B 5/02; B61C 13/04; B61F 13/00

(52) U.S. Cl. CPC B65G 1/065; B61B 5/02; B61C 13/04; B61F 13/00

(57) ABSTRACT

A shuttle (1) for a shelving system (100) is provided. The shuttle (1) comprises a loading area (2) which defines a loading surface (21) in a first direction (R1) and in a second direction (R2), wherein the loading area (2) is designed to receive goods to be transported, a loading device (3) which is designed to bring goods to and remove them from the loading area (2), at least one drive system (4) with a wheel system (41) which is rotatable about a wheel rotation axis (RD), wherein the at least one drive system (4) is designed to move the shuttle (1) in a horizontal direction and in a vertical direction in the shelving system (100). Furthermore, a passive shelving system (100) is provided, in particular for a high-bay warehouse.

### CROSS REFERENCE TO RELATED APPLICATIONS

This application is a National Stage of International Application No. PCT/EP 2023/072064 filed Aug. 9, 2023, claiming priority based on German Patent Application No. 10 2022 002 935.9 filed Aug. 11, 2022.

### BACKGROUND OF THE INVENTION

### Field

The present invention relates to a shuttle for a passive shelving system and a passive shelving system, in particular for a high-bay warehouse.

### Background

In the prior art, storage and retrieval units such as shuttles are known that can transport goods in a storage and retrieval system. Here it is often the case that the storage and retrieval unit can only move independently in a horizontal direction. To overcome a height difference in a vertical direction, the prior art often requires an external element such as an elevator or similar, which can move the storage and retrieval unit to different vertical levels. However, this poses the risk that the operation of such a storage and retrieval system could be impaired by a defect or malfunction of the elevator. In addition, controlling an elevator is difficult and error-prone. It is therefore desirable to create a storage and retrieval unit and a shelving system that offer increased reliability and simple control.

### SUMMARY OF THE INVENTION

The present invention solves this problem with a shuttle having the features of claim 1 and with a passive shelving system having the features of claim 29. Furthermore, the problem is solved with a use having the features of claim 30.

According to one aspect of the present invention, a shuttle for a shelving system is provided. The shuttle may comprise a loading area defining a loading surface in a first direction and in a second direction. The loading area may be designed to receive goods to be transported. The shuttle may comprise a loading device designed to bring goods to and remove them from the loading area. The shuttle can comprise at least one drive system with a wheel system that is rotatable about a wheel rotation axis. The at least one drive system can be designed to move the shuttle in a horizontal direction and in a vertical direction in the shelving system.

Compared to the known prior art, the shuttle according to one embodiment of the present invention offers the advantage that all functionalities which are necessary for a movement of the shuttle in a vertical direction and in a horizontal direction in a shelving system can be provided in the shuttle. In other words, the shuttle is suitable for operation in a passive shelving system on which no device needs to be provided that is responsible for overcoming a height difference in the vertical direction. Instead, the shuttle can move automatically (i.e. using its own drive) to a desired level in the vertical direction and also move horizontally in this level. This can make the overall system less susceptible to faults and facilitate maintenance, as all functionalities are combined in the shuttle. In other words, the shelving system can be designed to be passive (i.e. without active control). Thus, maintenance and operation of such an overall system (comprising at least a shuttle and the shelving system) can be simplified. For example, the shuttle as an individual unit can be replaced or repaired much more easily, whereas repairing the shelving system would be more complex.

The vertical direction can extend in the direction of gravity. The horizontal direction can be aligned orthogonally to the vertical direction. The shuttle can be a storage and retrieval unit that is set up to store and retrieve goods in a shelving system. The shuttle can be operated autonomously for this purpose. The shuttle can move independently. The loading area can be a surface on which goods can be arranged. For example, the loading area can be surrounded on two sides by a technical area. The technical area can include the necessary electronic and/or mechanical components for controlling the shuttle. This allows the loading area to be arranged particularly deep so that it is easy to pick up and drop off goods. The loading device can be a device that can transport goods onto the shuttle (i.e. into the loading area) and remove them again. For this purpose, the loading device can grip or move the goods. The drive system can be designed to travel on rails, which can be provided in the shelving system. The shuttle can preferably move along the rails in a horizontal direction. Furthermore, the drive system can be designed in such a way that it can move the shuttle in the vertical direction when interacting with the shelving system. The movement in the vertical direction can be exactly orthogonal to the horizontal direction. In other words, the shuttle can move strictly (i.e. exclusively) vertically. In other words, the shuttle can avoid a diagonal movement with horizontal and vertical components. This can save space, making the shelving system particularly efficient. Preferably, the shuttle has four drive systems. In a top view, the shuttle can have an essentially rectangular shape. A drive system can be provided at each corner of the shuttle. The wheel system of the drive system may be the rotating part of the drive system when the shuttle moves in the horizontal direction or in the vertical direction. The loading area is designed so that the goods can be transported directly on it. This means, for example, that there is no need to provide a transport container or the like into which the goods to be transported would have to be placed. This can be achieved by designing the loading area as a flat surface on which goods of any size or shape can be placed. The goods can be articles or items that can be shipped by mail order. The goods can include a variety of items from different areas such as clothing, electronics, DIY, food, sporting goods etc. Due to the different sizes and characteristics of the individual items, it is advantageous that the respective item can be picked up directly by the shuttle and stored and retrieved in the shelving system without the need for an additional transport device.

Preferably, the wheel system has a traction section for locomotion in the horizontal direction and an engagement section for locomotion in the vertical direction. The traction section can be designed in such a way that traction is created between the traction section and a driving surface, such as a rail, on which the shuttle can travel. The engagement section, on the other hand, can be a section that can move the shuttle in the vertical direction by mechanically engaging between the engagement section and a corresponding section, such as a vertical rail section, which can be provided on a shelf. The engagement section allows the shuttle to engage mechanically in a vertical rail section and be held there. If the wheel system is then driven in rotation, the shuttle can be moved upwards or downwards in the vertical direction by a continuous change of engagement situations. This can provide a safe movement sequence for the shuttle in the vertical direction. By providing a traction section and an engagement section on the wheel system, horizontal and vertical movement of the shuttle can be ensured by just one element. In other words, movement in the vertical direction and in the horizontal direction can be provided by the at least one drive system.

Preferably, the traction section and the engagement section are integrally formed. In other words, the traction section and the engagement section can be formed from one component (i.e. in one piece). This can mean that the traction section and the engagement section cannot be detached from each other in a non-destructive manner. Thus, a particularly simple configuration can be provided in which the traction section and the engagement section do not have to be driven separately.

Instead, a common drive can be used without the two components having to be connected to each other in a separate work step Preferably, the traction section and the engagement section can be driven by a common drive shaft. Preferably, the traction section is designed as an impeller for locomotion in the horizontal direction and preferably the engagement section is designed as a gear wheel for locomotion in the vertical direction. The traction section can be realized as a rubber wheel. More specifically, the traction wheel may comprise a running surface made of rubber. This allows the shuttle to be moved advantageously in the horizontal direction by driving the wheel system. The gear wheel can be designed to interact with a corresponding element on the shelving system in order to move the shuttle in the vertical direction. Due to the continuous state of engagement that can be achieved in this way, the shuttle can be held securely when moving in the vertical direction, even if it has loaded goods. Furthermore, the exact position of the shuttle in the vertical direction can be determined by a defined rotation of the gear wheel. In other words, the use of a gear wheel can prevent slippage between the wheel system and the shelving system when moving in the vertical direction, which means that the position of the shuttle can be determined with a high degree of accuracy. More precisely, the distance travelled by the shuttle can be determined by the number of revolutions of the wheel system. This makes it particularly easy to control the shuttle and steer it precisely to defined levels in the vertical direction.

Preferably, the impeller and the gear wheel are arranged coaxially on the drive system. In other words, the axes of rotation of the impeller and the gear wheel can be congruent. As a result, the control of the shuttle can be designed in the same way in a horizontal locomotion mode and in a vertical locomotion mode. The axes of rotation of the impeller and the gear wheel can both pass through the center of gravity of the impeller and the gear wheel. This can simplify the overall control of the shuttle. Furthermore, manufacturing the wheel system can be simplified, as both the impeller and the gear wheel can rotate around the same rotation axis.

Preferably, the impeller and the gear wheel can be driven by a common drive source. In other words, only one drive shaft (i.e. exclusively) can be provided for an impeller and a gear wheel. In other words, this means that no separate drive shafts are provided for the impeller and the gear wheel. This can save installation space, as only one drive shaft is provided. In a preferred embodiment, the drive system has a drive unit that is in direct contact with the wheel system. In other words, the wheel system can be directly connected to an electric motor or the same. On the one hand, this makes the drive system easier to control and, on the other hand, power transmission devices such as a drive shaft can be designed very simply, making it particularly easy to configure the drive system. In a further preferred embodiment, the drive system has no or only an extremely short drive shaft, since the electric motor is provided in the drive system. In other words, the drive system can comprise the electric motor. Thus, a high efficiency in driving the shuttle can be achieved, as there are no transmission losses due to transmission equipment (such as a coupling, gearbox, shaft or the like). Furthermore, the drive system can be realized as a compact drive unit.

Preferably, the shuttle has a steering system which is designed to pivot the at least one drive system about a drive system rotation axis. In other words, the drive system can be rotated about the drive system rotation axis. Preferably, the steering system is designed in such a way that the drive system can be pivoted into a horizontal forward movement position and into a vertical forward movement position. Preferably, the orientation of the drive system in the horizontal forward movement position is at a right angle to the drive system in the vertical forward movement position. In other words, the steering system can be designed such that it can pivot the drive system into exactly the two positions. In other words, the drive system can be pivoted by 90°±1° around the drive system rotation axis. In order to prevent further pivoting, the drive system and/or the shuttle can have a stop which is designed to prevent the drive system from pivoting beyond this. This can ensure that the drive system has a different orientation in the horizontal forward movement position than in the vertical forward movement position. In other words, in the horizontal forward movement position, the traction section can interact with a rail section of the shelving system, for example, to move the shuttle in the horizontal direction. Furthermore, in the vertical forward movement position, the engagement section can interact with a corresponding element on the shelving system (e.g. a toothed rail) to advance the shuttle in the vertical direction. When transferring the drive system from the horizontal movement position to the vertical movement position, the drive system can be rotated around the drive system rotation axis as long as the drive system (e.g. the traction section) is in contact with the driving surface. The steering system can have two guide rails that are arranged parallel to each other. A threaded spindle (also known as a motion screw) may be provided between the two guide rails. Furthermore, the steering system can comprise a steering system drive that can generate a rotary movement. The threaded spindle can be used to convert a rotational movement of the steering system drive into a translational movement along the guide rails. The threaded spindle can be formed from a threaded rod, i.e. a cylindrical round rod, to which a trapezoidal or flat thread is applied in one embodiment. It is also conceivable to provide a ball screw or a roller screw. Furthermore, the steering system can comprise a sensor that can measure the rotation of the threaded spindle and thus determine the translational movement. This allows the position of the at least one drive system to be determined with high precision. Furthermore, the steering system can have a thrust element which can be set into a translatory movement by the threaded spindle. Furthermore, the thrust element can be mounted on the two guide rails. This can ensure a defined translational movement of the thrust element. A steering rod, which is connected to the drive system, can be articulated on the thrust element. Preferably, the steering rod is arranged on the drive system in such a way that the drive system can be rotated about the drive system rotation axis by a translatory movement of the screwing element. In a preferred embodiment, the rotational movement of the steering system drive is transmitted to two threaded spindles simultaneously or synchronously. Furthermore, the steering system can have two thrust elements, each of which can be moved in translation by a threaded spindle. Accordingly, one steering system can be assigned to two drive systems. In other words, by driving a steering system drive, two drive systems can be pivoted in synchronization with each other. This can ensure that two drive systems always have a corresponding position. In other words, can thus ensure that at least two drive systems are both positioned either in the horizontal movement position or in the vertical movement position. Consequently, the control of a steering process of the shuttle (or the drive systems) can be simplified.

Preferably, the drive system rotation axis is orthogonal to the wheel rotation axis. For example, when the drive system is rotated about the drive system rotation axis, the wheel rotation axis, about which the traction section and the engagement section in particular are rotatable, can rotate at the same time. In this way, the change between a horizontal forward movement position and a vertical forward movement position can be realized by rotating the drive system about the drive system rotation axis

Preferably, the steering system is designed to apply a preload force to at least one drive system. In other words, the drive system can be designed to apply a force to the drive system which counteracts movement of the drive system about the drive system rotation axis. In this way, the drive system can be stabilized when the shuttle moves in the horizontal direction of movement and fluttering of the drive system can be avoided. This allows the shuttle to reach particularly high speeds, ensuring efficient operation of a shelving system. Furthermore, if the shelving system has a toothed rail in which the gear wheel of the drive system engages in a vertical forward movement position of the shuttle, it can be ensured that initial meshing between the drive system (or wheel system) and the toothed rail of the shelving system functions smoothly. For example, when a tooth of the toothed wheel and a tooth of the toothed rail meet, the steering system can be designed to be elastic enough to ensure that the toothed wheel and the toothed rail are gently clamped or slide in. This can be realized, for example, by a spring element that is arranged in the feed element or thrust element of the steering system. However, it is also conceivable that any other element that enables elastic load absorption can be provided in the steering system. For example, the steering system drive can also have such an elastic element in the form of a spiral spring or similar. Furthermore, the connection between the threaded spindle and the feed element or thrust element can be realized by an elastic element such as an elastomer element. In the present aspect, it is only important that a preload force can be applied to the drive system by the steering system.

Preferably, the steering system comprises at least one spring element, which is designed to exert the preload force on the drive system. The spring element can serve as an elastic element, which enables elastic load absorption, and as a preload element, which can exert the preload force on the drive system. The dual function of the spring element makes it possible to achieve a simple and compact design of the steering system.

Preferably, the steering system comprises an actuator for generating a force and a linkage for transmitting the force of the actuator to the at least one drive system. The actuator can be the steering system drive. The linkage can comprise the guide rails and the threaded spindle. In this way, a translational movement force can be applied to the drive system or drive systems, and the respective drive system and the drive system rotation axis can be rotated or pivoted.

Preferably, the shuttle comprises two steering systems, each of which is connected to two drive systems, wherein each steering system is preferably designed to control two drive systems synchronously. In other words, the shuttle can comprise a total of four drive systems (e.g. one at each corner of the shuttle). A steering system can be provided between each two drive systems, which can be connected to the two drive systems. This means that two drive systems of the shuttle can be pivoted synchronously by two steering systems around the respective drive system rotation axis. This can simplify control of the shuttle.

Preferably, the drive system has at least one drive system guide roller, which is rotatable about a first guide roller rotation axis. The drive system guide roller can be designed to support the shuttle in a vertical direction of movement relative to a corresponding element on the shelving system. In the case where several drive systems are provided on the shuttle, the drive system guide rollers can be designed in such a way that at least two drive system guide rollers are supported on the shelving system in such a way that the shuttle is braced in the shelving system. More precisely, the shuttle can thus be reliably held in the shelving system when moving in the vertical direction of movement, so that the drive system of the shuttle can reliably move in the vertical direction of movement. More precisely, it can thus be ensured that a gear wheel that is engaged with a corresponding toothed rail on a shelving system cannot fall out of this engaged state. For this purpose, the drive system guide roller can be provided on the drive system and can be pivoted together with the drive system about the drive system rotation axis. This ensures that the shuttle can be easily operated in the shelving system.

Preferably, the first guide roller rotation axis is arranged orthogonally to the wheel rotation axis. In other words, the drive system guide roller is arranged on the drive system in such a way that the first guide roller rotation axis is orthogonal to the wheel rotation axis. This ensures that the movement of the shuttle can be safely guided in the vertical direction of movement. This means that the shuttle can only be moved in the desired vertical direction of movement (as long as the drive systems are positioned in the vertical movement position). This can further increase the operational safety of the shuttle in a shelving system.

Preferably, the shuttle has at least one lifting system that is designed to lift the shuttle from a driving surface. The driving surface can, for example, be a rail section or its driving surface, which is provided in the shelving system. Thus, the lifting system can preferably be designed in such a way that the shuttle can be lifted on a narrow rail section relative to the shuttle. Preferably, the lifting system can be designed to lift the shuttle in the vertical direction of movement so that the wheel system loses contact with the ground. In other words, the lifting system can be designed to transfer the shuttle between a horizontal movement position and a swivel position in which the drive system no longer contacts a driving surface. More specifically, the lifting system can lift the traction section, which can interact with a rail section, from the rail section. This allows the drive system to be advantageously pivoted around the drive system's rotation axis, as the traction section is no longer in contact with the rail section of the shelving system. This can further increase the efficiency of the shuttle's operation.

Preferably, the lifting system comprises an actuator for generating a force, a linkage and at least one lifting unit. Preferably, the lifting unit is held movable in a third direction, which is orthogonal to the first and/or the second direction. The lifting unit can be movably mounted. Preferably, the linkage is designed to transmit the force of the actuator to the at least one lifting unit in order to move the lifting unit in the third direction. The actuator can be a lifting system drive that generates a rotational force. In particular, the rotational movement can be transmitted to a lifting system linkage (i.e. the linkage) via a gearbox. In this way, the rotational movement of the lifting system drive can be transmitted to at least one lifting unit. The lifting unit can be designed to convert the rotational movement, which is transmitted via the lifting system linkage, into a translational movement in the third direction. This means that the exact position of the lifting unit can be determined by detecting the rotation of the lifting system linkage and/or the lifting system drive. This allows the lifting or lowering of the shuttle in the third direction to be controlled precisely.

Preferably, the at least one lifting unit has a control curve element in which the linkage is guided by means of a cam. In other words, a cam can be provided at one end of the lifting system linkage, which is not rotationally symmetrical about the rotation axis of the lifting system linkage. The cam can be guided in a control curve element so that the lifting element can have a specific position in the third direction depending on the angular position of the lifting system linkage. By knowing the control curve of the control curve element and precisely detecting the revolutions of the lifting unit, it is possible to raise or lower the shuttle precisely. The lifting unit can be guided in such a way that it can only move in the third direction. In other words, all other degrees of freedom can be blocked by the guide of the lifting unit.

Preferably, the at least one lifting unit has a lifting system guide roller which is rotatable about a second guide roller rotation axis. The lifting system guide roller can be designed to bring the shuttle into a desired position on the rail section of the shelving system. For example, at a transition between two adjacent rail sections (e.g. a rail section of a shelving area and a rail section of a riser area), the lifting system guide roller can optimally position the shuttle on the rail section through contact with an element (e.g. a guide element) of the shelving system. This ensures problem-free operation of the shuttle in a shelving system, even in a case where different rail sections do not fit together perfectly.

Preferably, the second guide roller rotation axis is parallel to the drive system rotation axis. This ensures that contact between the lifting system guide roller and an element of the shelving system does not lead to a braking effect during the horizontal movement of the shuttle, as the roller can rotate around the second guide roller rotation axis.

Preferably, the loading device has an upper table extending in the first direction and a goods contact element extending in the second direction. Preferably, the goods contact element is movably fixed to the upper table. In other words, the goods contact element can protrude into the loading area. In contrast, the upper table can limit the loading area. The goods contact element can be moved along the upper table in the first direction. For this purpose, the goods contact element can have a goods contact element drive, which can convert a rotational movement into a translational movement of the goods contact element in the first direction. This allows a good to be pushed out of the loading area. Furthermore, a good can be pushed onto the loading area.

Preferably, the upper table is designed so that the goods contact element is movable in the first direction. For this purpose, the upper table can have a guide rail on which the goods contact element can be moved. Furthermore, a toothed rail can be provided in or on the guide rail, in which a rotatably drivable gear wheel of the goods contact element engages. This allows the goods contact element to be moved along the rail.

Preferably, the upper table is movable relative to the loading area in the first direction. In other words, the upper table can extend over the entire length of the goods area in the first direction. Due to the movability, the upper table can be moved beyond the loading area. Together with the upper table, the goods contact element can therefore also be moved out of the loading area. This means, for example, that goods located in a shelf area can be picked up by the upper table together with the goods contact element. Furthermore, a good located in the loading area of the shuttle can be contacted by the goods contact element and then moved from the loading area to a shelf area by moving the upper table.

Preferably, the loading device comprises a center table which is movable relative to the loading area and to which the upper table is movably fixed. In other words, the loading device can provide a telescopic extension option for the upper table and the center table. This allows goods to be stored (i.e. moved) even further in the first direction into a shelf area. Furthermore, the shuttle can be designed to be more compact, as twice the length of the loading area in the first direction is theoretically available as a possible reach of the shuttle or loading device.

Preferably, the upper table has a gripper finger at at least one end in the first direction, which is movable between a gripping position and a stowed position. This means that the gripper finger can be moved back and forth between two positions. In the gripping position, the finger can be designed in such a way that it can clamp a good together with the goods contact element so that it is clamped between the gripper finger and the goods contact element. In this way, a good can be reliably gripped and moved back and forth in the first direction. In the stowed position, on the other hand, the gripper finger can be arranged so that it is aligned with the upper table in the first direction. This means that the upper table can easily be moved past a good without the gripper finger unintentionally displacing the good. If the upper table is then next to the goods to be moved, the gripper finger can be moved into the gripping position in order to grip behind the goods. The upper table can then be retracted again and thus convey the goods to the loading area. According to one aspect of the present invention, the goods contact element can first be moved along the upper table in the first direction in such a way that the goods are clamped between the gripper finger and the goods contact element. In this way, a particularly safe transport of the goods can be realized by the loading device.

Preferably, the gripper finger is articulated on the upper table so that the gripper finger can be pivoted. Accordingly, it is conceivable that the gripper finger can be moved back and forth between the gripping position and the stowed position by a drive unit located on the upper table. This enables a particularly simple design of the gripper finger, for example as a metal plate, which is hinged to the upper table.

Preferably, one gripper finger is provided at each end in the first direction of the upper table. Both gripper fingers can be identically designed. In other words, the goods contact element can be moved back and forth between two gripper fingers on the upper table. This makes it easy to store or retrieve goods from a shelf area on both sides of the shuttle. In other words, it does not matter on which side of the shuttle a shelf area is adjacent, as the conveyor device can store and/or retrieve goods on both sides in the first direction.

According to a further aspect of the present invention, a passive shelving system, in particular for a high-bay warehouse, is provided, wherein the shelving system comprises: a shuttle according to one of the above embodiments, a shelving area with at least two shelves at different vertical positions, at least two shelf rail sections each extending along the at least two shelves, wherein the shelf rail sections are configured such that the shuttle can move horizontally on the shelf rail sections, at least one passive riser area which connects the shelf rail sections to each other and is designed so that the shuttle can move through the riser area from one shelf rail section to another shelf rail section in the vertical direction of movement. The shelving system can be an area in which the goods or articles can be stored. Furthermore, the shelving system can have transport sections, such as shelf rail sections, which are designed to enable the shuttle to automatically transport goods into and out of the shelving area. The shelves of the shelving system can be horizontal structures on which goods can be placed. The shelves can be parallel to the horizontal. Furthermore, the shelves can be arranged one above the other (i.e. in the direction of gravity or the vertical direction). In other words, the shelves can be provided at different vertical positions. Preferably, the shelving system comprises a plurality of shelves, each arranged at a different vertical position. Each shelf can define a shelf level that defines a vertical position. This means that the shelving system can have a number of shelf levels on top of each other. The shelves can be held in place by vertical support pillars. Preferably, the shelves are essentially flat so that goods can be placed on them without any problems and remain in their deposited position. Flat here means that no structures or partitions are provided on the shelves. In other words, the shelves are designed to hold goods individually. This means that no prior definition of specific storage areas is necessary and goods can be placed on the shelves completely individually. The shelves can define a continuous and flat plane on which goods can be placed directly (i.e. without containers or the like). Preferably, the shelves are continuous. This allows the warehouse to be operated highly efficiently, as goods can be stored individually adjacent to neighboring goods. In other words, goods can be stored individually next to each other and/or behind each other on the shelves. This means that it is not necessary to determine in advance which goods are to be stored in any pre-formed or limited storage areas of the shelving area. Furthermore, the shelving system can accommodate goods without additional transport equipment, such as transport boxes or the like. This can further increase the efficiency of the shelving system.

By using the shuttle, the shelving system can be completely passive. In other words, no active control of the shelving system may be necessary to provide a fully automated shelving system. More specifically, the shelving system may be operated by the actively controlled shuttle such that the shelving system does not need to perform any actively controlled movement or the like. Rather, the shelving system can be passive and merely controlled in response to certain interactions caused by the shuttle. This means that a particularly robust and easy-to-control shelving system can be provided. Furthermore, no operating errors can occur due to incorrect control of the shelving system, as the shelving system does not need to be controlled. This can increase the reliability of the shelving system, ensuring that goods can be stored and retrieved safely at all times.

Individual aspects or embodiments can be combined with other features or embodiments to form new embodiments. The embodiment and effects mentioned in in connection with the features or embodiments also apply analogously to the new embodiments.

### BRIEF DESCRIPTION OF THE DRAWINGS

In the following, preferred embodiments of the present invention are described with reference to the accompanying figures.

FIG. 1 is a schematic and perspective view of a shuttle according to an embodiment of the present invention.

FIG. 2 is a schematic and perspective view of a drive system according to an embodiment of the present invention.

FIG. 3 is a schematic and perspective view of a steering system according to an embodiment of the present invention.

FIG. 4 is a schematic and perspective view of a lifting system according to an embodiment of the present invention.

FIG. 5 is a schematic view of the operation of a lifting system according to one embodiment of the present invention.

FIG. 6 is a schematic top view of a loading area of a shuttle according to an embodiment of the present invention.

FIG. 7 is a schematic and perspective view of a loading device according to an embodiment of the present invention.

FIG. 8 is a schematic top view of a loading device according to an embodiment of the present invention.

FIG. 9 is a schematic and perspective view of a loading device according to an embodiment of the present invention.

FIG. 10 is a schematic and perspective view of a shelving system according to an embodiment of the present invention.

### DETAILED DESCRIPTION OF THE INVENTION

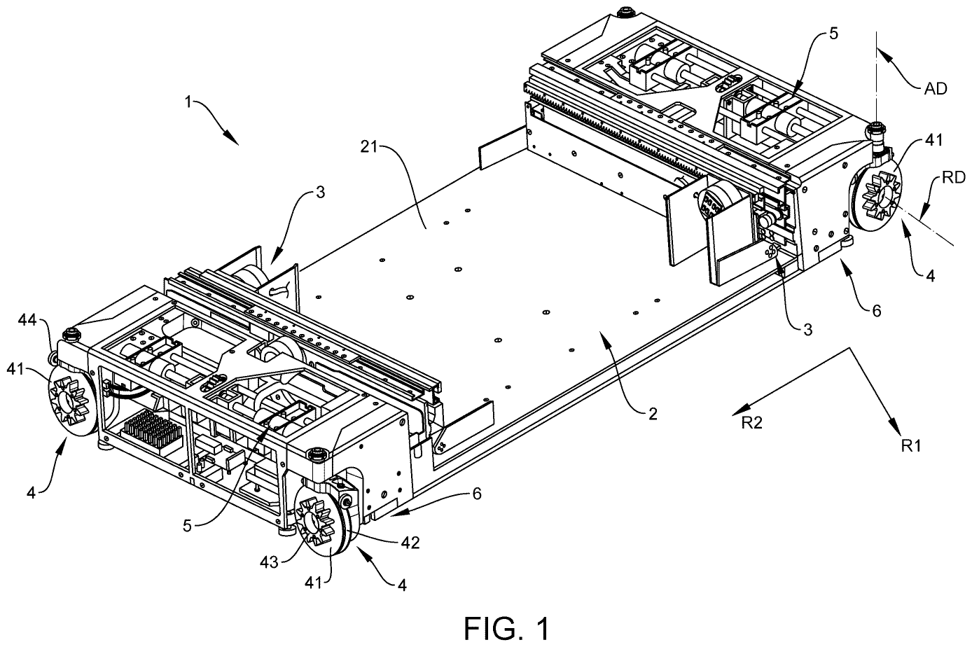

FIG. 1 is a schematic and perspective view of a shuttle 1 according to an embodiment of the present invention. In the present embodiment, the shuttle 1 or storage and retrieval unit is an autonomously controllable system which can store and/or retrieve goods in a shelving system 100 (not shown in FIG. 1). In the present embodiment, the shuttle 1 has an essentially rectangular shape in a top view. Furthermore, the shuttle 1 has a loading area 2 with a loading surface 21 for receiving the goods or articles. The loading area 21 is bounded on two sides by a respective loading device 3. The loading area 21 is open on the other two sides in order to store or retrieve goods on the loading area 21. The loading device 3 is designed to bring goods to the loading area 2 and remove them from it. Furthermore, the shuttle has at least one drive system 4 with a wheel system 41, which is rotatable about a wheel rotation axis RD. The drive system 4 is designed to move the shuttle 1 in a horizontal direction HR and in a vertical direction VR in the shelving system 100. In the present embodiment, the shuttle 1 has four identical wheel systems 4, each at one corner of the shuttle. Furthermore, the drive systems 4 are pivotable about a drive system rotation axis AD. More precisely, the drive systems 4 can be swiveled from a horizontal forward movement position to a vertical forward movement position. In FIG. 1, the drive systems shown on the right-hand side of the Fig. (only one drive system is visible) are arranged in the horizontal forward movement position. In contrast, in the embodiment shown in FIG. 1, the two drive systems 4 on the left are arranged in the vertical forward movement position. This means that the drive systems can be pivoted by essentially 90° in order to be pivoted from the horizontal forward movement position into the vertical forward movement position or vice versa.

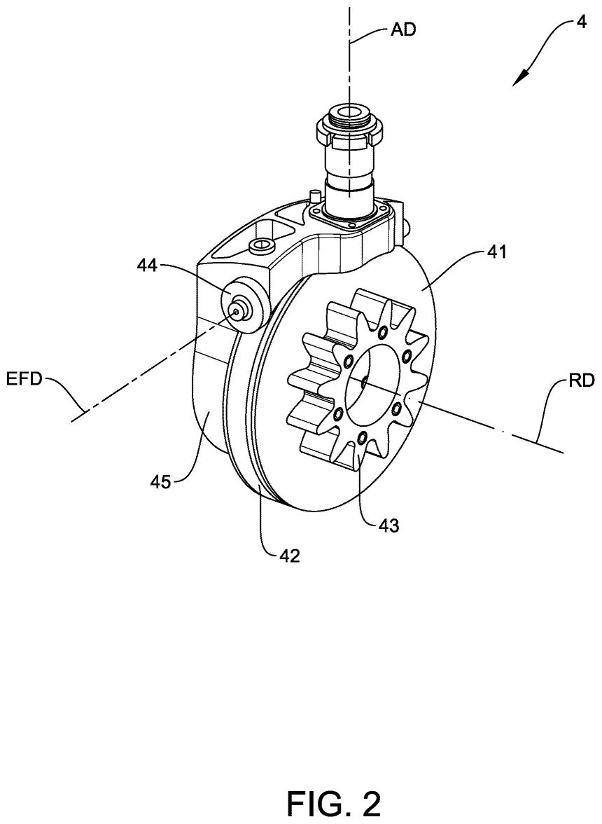

FIG. 2 is a schematic and perspective view of a drive system 4 according to an embodiment of the present invention. In FIG. 2, it can be seen that the wheel system 41 of the drive system 4 comprises a traction section 42 in the form of an impeller with a rubberized running surface and an engagement section 43 in the form of a gear wheel. The traction section 42 can be formed by a rubberized impeller or the like. Furthermore, the drive system 4 has a motor housing 45, in which a drive unit for driving the wheel system 41 about the wheel rotation axis RD is accommodated. The motor housing 45 is integral with a mounting for the wheel system 41. This allows a particularly compact drive system 4 to be realized, which can be easily rotated about a drive system rotation axis AD. For this purpose, the drive system 4 can be connected or connectable to the shuttle 1 by means of a pivot, so that the drive system 4 can be rotated about the drive system rotation axis AD. Furthermore, the drive system 4 has a drive system guide roller 44, which is designed in the form of a wheel ring. The drive system guide roller 44 is designed to interact with an element (for example a rail or a shelf post) of the shelving system 100 in order to support the shuttle 1 during a vertical movement. The drive system guide roller 44 can be rotated about a first guide roller rotation axis EFD.

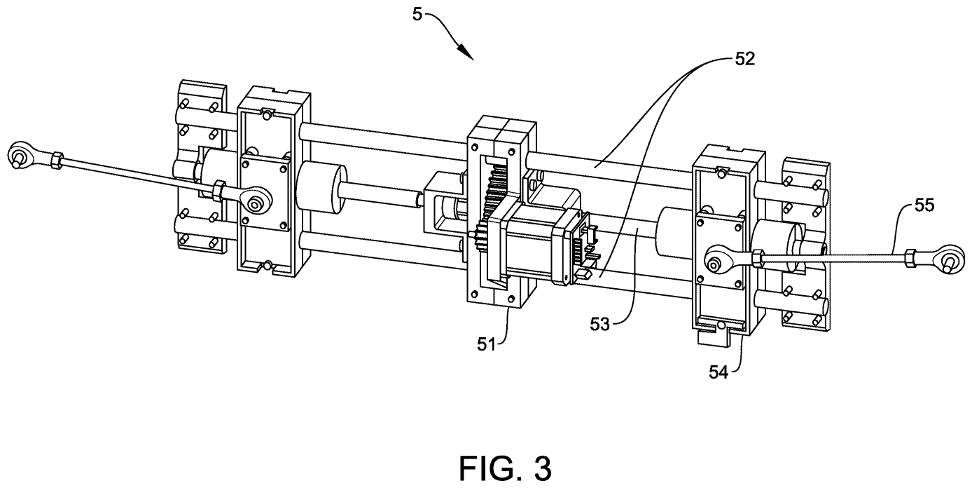

FIG. 3 is a schematic representation of a steering system 5, which is designed to rotate two drive systems 4 of the shuttle 1 about the drive system rotation axis AD. In the present embodiment, the shuttle 1 has two steering systems 5, each of which can actuate two drive systems 4. The steering system 5 has a steering system drive 51 that can generate a rotational movement. The rotary movement is applied to a threaded spindle 53 by means of a gearbox. The threaded spindle 53 moves a thrust element 54 in translation. In other words, the rotational movement of the steering system drive 51 is converted into a translational movement of the thrust element 54. The thrust element 54 is mounted on two guide rails 52 running parallel to each other. A steering rod 55, which is in contact with a drive system 4 in each case, is attached to the thrust element 54. The steering rod is articulated on the thrust element 54 and on the drive system 4. Thus, a rotary movement can be exerted on the drive system 4 in order to rotate it about the drive system rotation axis RD. Preferably, the steering system 5 is designed symmetrically so that two drive systems 4 can be rotated or pivoted by just one steering system drive 51. This can ensure synchronous pivoting of two drive systems.

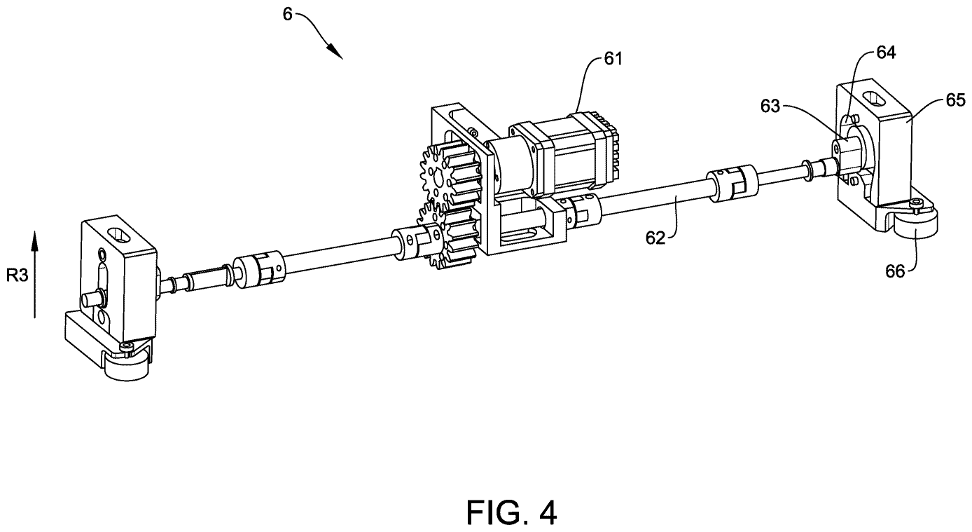

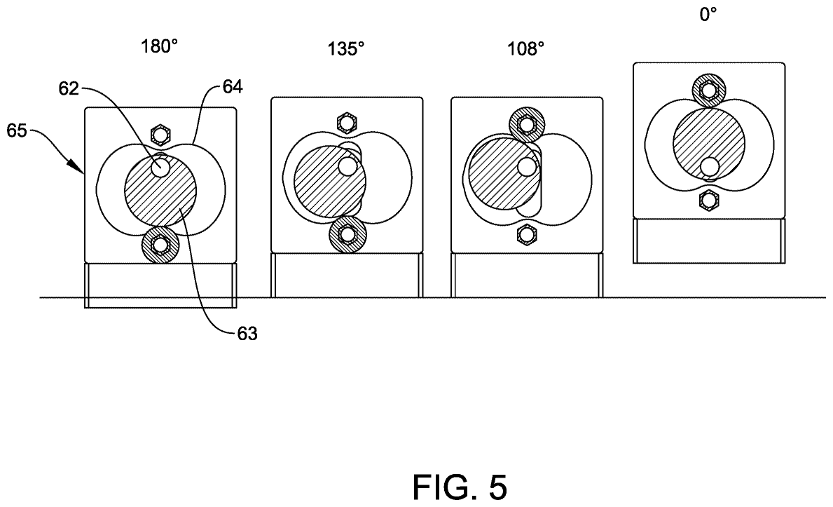

FIG. 4 is a schematic view of a lifting system 6 according to an embodiment of the present invention. The lifting system 6 is designed to lift the shuttle 1 from a driving surface (for example, from a rail section). In the embodiment shown in FIG. 1, the shuttle 1 has two lifting systems 6. The lifting systems 6 are arranged in close proximity to the drive systems 4. This allows the shuttle 1 to be lifted in such a way that the drive systems 4 can be easily rotated in a drive system rotation axis AD. The lifting system 6 has a lifting system drive 61 which can generate a rotational movement. This rotary movement is transmitted to a lifting system linkage 62 by means of a gearbox. This lifting system linkage 62 rotationally drives a cam 63. The cam 63 is guided by a control curve element 64 of a lifting unit 65. Furthermore, the cam 63 is not connected to the lifting system linkage 62 at its center point (i.e. its center of gravity). Thus, the lifting unit 65 can be moved in the third direction R3 by rotationally driving the cam 63 in cooperation with the control curve element 64. Thus, for example, a predetermined stroke of the lifting unit 65 can be realized when the lifting system linkage 62 is rotated by 180°. This means that the shuttle 1 can be lifted a certain distance from the driving surface by a defined drive of the lifting system drive 61. More precise details on the control curve follow in connection with the description of FIG. 5. Furthermore, the lifting system 6 has a lifting system guide roller 66, which is designed to bring the shuttle 1 into an optimum position on the driving surface, in particular in the first direction R1. In this way, the lifting system guide roller 66 can ensure that the shuttle 1 always travels centrally on a travel surface (for example a rail system).

FIG. 5 is a schematic view of the cam 63 and the lifting unit 65, in which the cam 63 is guided in cooperation with the control curve element 64. In the first view shown in FIG. 5 (view on the left-hand side of FIG. 5), the lifting unit 65 is positioned in such a way that the shuttle does not stand with the drive system 4 on the driving surface, but with the lifting unit 65. In the present example, the shuttle is raised by four mm from the driving surface. This is sufficient to rotate the drive systems 4 about the drive system rotation axis RD in order to move from the horizontal movement position to the vertical movement position. To reach this position, an angular position of 180° of the lifting system linkage 62 may be present. In the second following image in FIG. 5, the height of the lifting unit 65 corresponds exactly to the height of the drive system 4. This means that the shuttle 1 is standing both on the lifting unit 65 and on the drive system 4. In this case, it is possible to move the shuttle 1 without any goods on it. The angular position can be 135°. In the next illustration shown in FIG. 5 (third Fig. from the left-hand side), the lifting unit 65 is in the same position as in the position described above, with the difference that the angular position of the lifting system linkage 62 is 108°. Finally, in the illustration shown on the right-hand side in FIG. 5, the lifting unit 65 is raised from the driving surface in order to also enable the shuttle 1 to be moved with a good on it. In this case, the angular position of the lifting system linkage 62 can be 0°. Thus, the position of the lifting unit 65 can be variably realized by rotating the lifting system linkage 62.

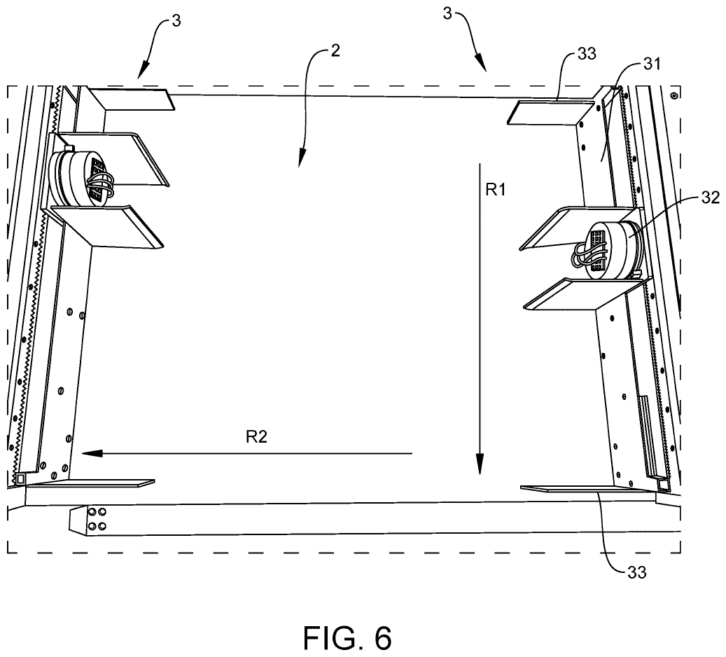

FIG. 6 is a schematic top view of a loading area 2 of a shuttle 1 according to an embodiment of the present invention. The loading area 2 is bounded in the second direction R2 by a respective loading device 3. The loading device has an upper table 31 extending in the first direction R1 and a goods contact element 32 extending in the second direction R2. The goods contact element 32 is movably fixed to the upper table 31 and can be moved in the first direction R1. Furthermore, the loading device 3 has a gripper finger 33 which is not movable in the first direction. Rather, the gripper finger 33 is pivotable such that it is either in a position in which it projects into the loading area 3 or in a position in which it is aligned with the upper table 31 in the first direction (i.e. does not project into the loading area 3). At of the present embodiment, the upper table 31 has such a gripper finger 33 on each side. As a result, goods to be transported can be clamped between the goods contact element 32 and the gripper finger 33 and thus be moved on the loading area 2 or transported away from the loading area 2 or transported thereon.

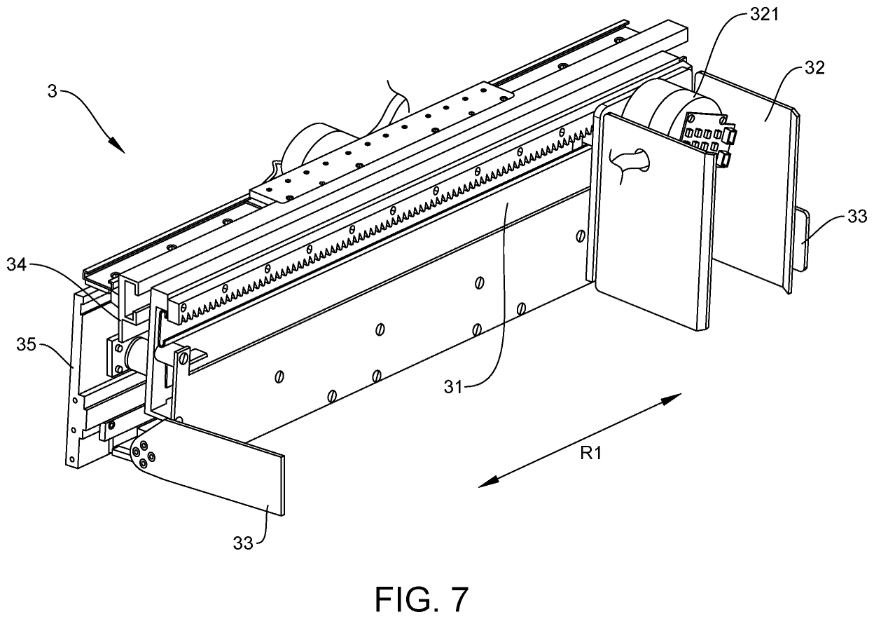

FIG. 7 is a schematic and perspective view of a single loading device 3, as installed in the embodiment of the shuttle 1 shown in FIG. 1. More precisely, two of the loading devices shown in FIG. 7 are provided as the boundary of the storage area 2 on the shuttle 1. In FIG. 7, it can be seen that the goods contact element 32 is movable along a toothed rail in the first direction R1 along the upper table 31 by a goods contact element drive unit 321. The upper table 31 is also movable relative to a center table 34. The center table 34 is movably mounted on a base table 35. Thus, the conveyor unit 3 can be extended telescopically in the first direction R1. In other words, the upper table and the center table 34 can be extended in the first direction as desired or variably.

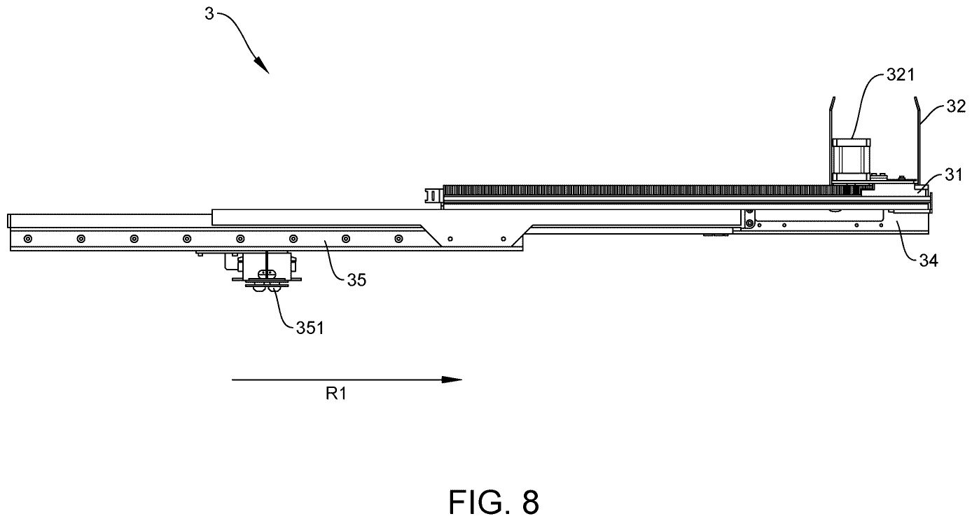

FIG. 8 is a schematic top view of the conveyor unit 3 in a state in which the upper table 31 and the center table 34 are extended telescopically in the first direction. The center table 34 is moved relative to the base table 35. The base table can have a base table drive 351, which can be designed to move the center table 34 and/or the upper table 31 in the first direction R1.

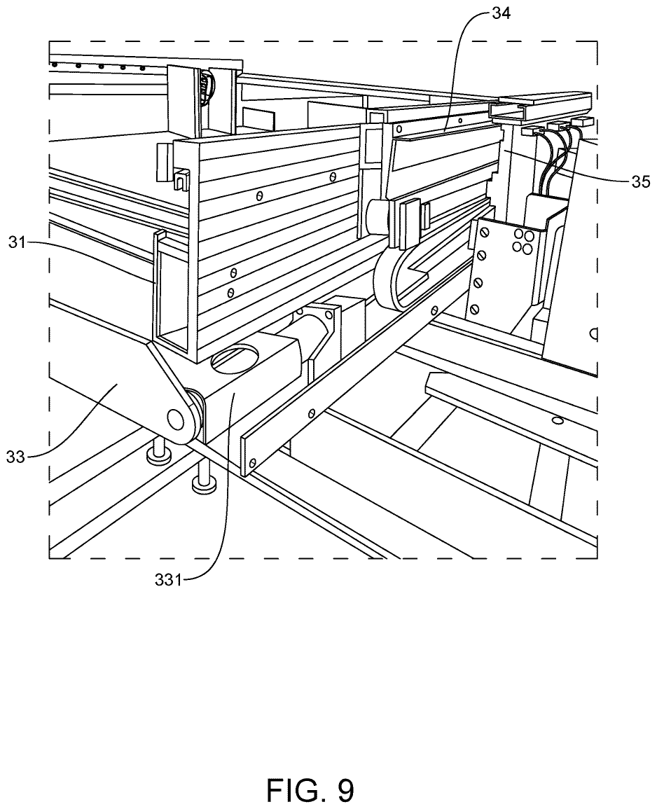

FIG. 9 is a schematic partial view of the loading device 3 in an extended state. It can be seen here that the upper table 31 is displaced relative to the center table 34. Furthermore, the center table 34 is displaced relative to the base table 35. The displacement takes place in the first direction R1. The gripper finger 33 is pivotably mounted on the upper table 31. The gripper finger 33 is moved from the gripping position to the retracted position by a gripper finger drive 331. In a preferred embodiment, both gripper fingers 33 of an upper table 31 are moved synchronously with one another by the same gripper finger drive unit 331.

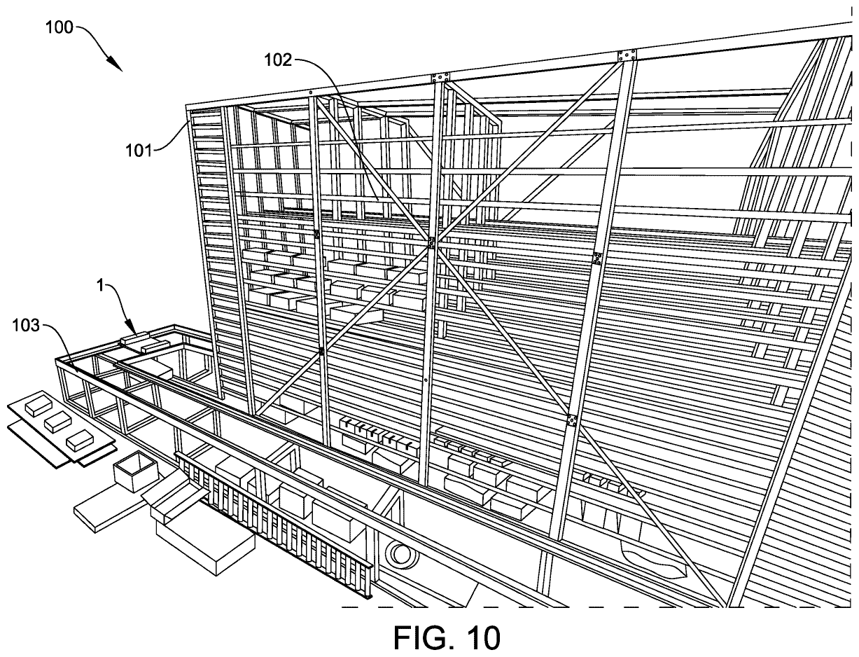

FIG. 10 is a schematic and perspective view of a passive shelving system 100 according to an embodiment of the present invention. The shelving system 100 has a riser area 101 and a shelf area 102. The shelving area 102 has a plurality of shelves at different vertical positions. Adjacent to the shelves are shelf rail sections on which the shuttle 1 can travel. In order to reach the various levels between the shelves, the shelving system has a riser area 101. In the riser area 101, the shuttle 1 can move automatically in the vertical direction. An infeed section 103 is arranged in front of the riser area 101, via which the shuttle 1 reaches the shelving system 100. In the present embodiment, the shelving area 102 is bounded at each end by a riser area 101. In this way, a kind of traffic circle can be achieved in which a large number of shuttles 1 can travel without obstructing each other. The riser area 101 has four toothed rails with which the drive system (or more precisely the drive system gear wheel) can engage. By driving the drive system around the wheel rotation axis, the shuttle 1 can thus move in the vertical direction. Once the shuttle 1 has arrived at the desired level, it can rotate the drive systems 4 around the drive system rotation axis so that the shuttle can leave the riser area on the traction section in a horizontal direction.

### LIST OF REFERENCE SYMBOLS

1 Shuttle
2 Loading area
3 Loading device
4 Drive system
5 Steering system
6 Lifting system
21 Loading surface
31 Upper table
32 Goods contact element
321 Drive unit
33 Gripper fingers
331 Gripper finger drive
34 Center table
35 Base table
351 Base table drive
41 Wheel system
42 Traction section
43 Engagement section
44 Drive system guide roller
45 Motor housing
51 Steering system drive
52 Guide rails
53 Threaded spindle
54 Screw element
55 Steering rod
61 Lifting system drive
62 Lifting system linkage
63 Cams
64 Control curve element
65 Lifting unit
66 Lifting system guide roller
100 Shelving system
101 Riser area
102 Shelf area
103 Infeed section
R1 first direction
R2 second direction
R3 third direction
AD Drive system rotation axis
RD Wheel rotation axis
EFD First guide roller rotation axis

1.-30. (canceled)

31. A shuttle (1) for a shelving system (100), comprising,
a loading area (2) which defines a loading surface (21) in a first direction (R1) and in a second direction (R2), wherein the loading area (2) is designed to receive goods to be transported,
a loading device (3) which is designed to bring goods to the loading area (2) and remove them from it,
at least one drive system (4) with a wheel system (41) which is rotatable about a wheel rotation axis (RD), wherein the at least one drive system (4) is designed to move the shuttle (1) in a horizontal direction and in a vertical direction in the shelving system (100),
wherein the wheel system (41) comprises a traction section (42) for traveling in the horizontal direction and an engagement section (43) for traveling in the vertical direction, and
wherein the shuttle (1) comprises a steering system (5) which is designed to pivot the at least one drive system (4) about a drive system rotation axis (AD).

32. The shuttle (1) according to claim 31, wherein the traction section (42) and the engagement section (43) are drivable by a common drive shaft

33. The shuttle (1) according to claim 31, wherein the traction section (42) is configured as an impeller for locomotion in the horizontal direction, and wherein the engagement section (43) is configured as a gear wheel for locomotion in the vertical direction.

34. The shuttle (1) according to claim 33, wherein the impeller and the gear wheel are arranged coaxially on the drive system (4).

35. The shuttle (1) according to claim 33, wherein the impeller and the gear wheel are drivable by a common drive source.

36. The shuttle (1) according to claim 31, wherein the shuttle (1) comprises a steering system (5) which is designed to pivot the at least one drive system (4) about a drive system rotation axis (AD).

37. The shuttle (1) according to claim 36, wherein the steering system (5) has a thrust element (54) which can be set into a translatory movement by a threaded spindle (53).

38. The shuttle (1) according to claim 36, wherein the drive system rotation axis (AD) is orthogonal to the wheel rotation axis (RD).

39. The shuttle (1) according to claim 36, wherein the steering system (5) is designed to apply a preload force to at least one drive system (4).

40. The shuttle (1) according to claim 39, wherein the steering system (5) comprises at least one spring element which is designed to exert the preload force on the drive system (4).

41. The shuttle (1) according to claim 36, wherein the steering system (5) comprises an actuator for generating a force and a linkage for transmitting the force of the actuator to the at least one drive system (4).

42. The shuttle (1) according to claim 31, wherein the drive system (4) comprises at least one drive system guide roller which is rotatable about a first guide roller rotation axis (EFD).

43. The shuttle (1) according to claim 42, wherein the first guide roller rotation axis (EFD) is arranged orthogonally to the wheel rotation axis (RD).

44. The shuttle (1) according to claim 31, wherein the shuttle (1) comprises at least one lifting system (6) designed to lift the shuttle (1) from a driving surface.

45. The shuttle (1) according to claim wherein the lifting system (6) comprises an actuator for generating a force, a linkage and at least one lifting unit (65).

46. The shuttle (1) according to claim 45, wherein the lifting unit (65) is held movable in a third direction, which is orthogonal to the first and/or the second direction.

47. The shuttle (1) according to claim 45, wherein the at least one lifting unit (65) has a control curve element (64) in which the linkage is guided by means of a cam (63).

48. The shuttle (1) according to claim 45, wherein the at least one lifting unit (65) comprises a lifting system guide roller (66) which is rotatable about a second guide roller rotation axis.

49. The shuttle (1) according to claim 48, wherein the second guide roller rotation axis is parallel to the drive system rotation axis (RD).

50. The shuttle (1) according to claim 31
wherein the loading device (3) has an upper table (31) extending in the first direction (R1) and a goods contact element (32) extending in the second direction (R2), and
wherein the goods contact element (32) is movably fixed to the upper table (31).

51. The shuttle (1) according to claim 50, wherein the upper table (31) is configured such that the goods contact element (32) is movable in the first direction (R1).

52. The shuttle (1) according to claim 50, wherein the upper table (31) is movable relative to the loading area (2) in the first direction (R1).

53. The shuttle (1) according to claim 49, wherein the loading device (3) comprises a center table (34) which is movable relative to the loading area (2) and to which the upper table (31) is movably fixed.

54. The shuttle (1) according to claim 49, wherein the upper table (31) comprises a gripping finger (33) at at least one end in the first direction (R1), which is movable between a gripping position and a stowed position.

55. The shuttle (1) according to claim 54, wherein the gripper finger (33) is hingedly mounted on the upper table (31) so that the gripper finger (33) is pivotable.

56. The shuttle (1) according to claim 54, wherein a gripper finger (33) is provided at each end in the first direction of the upper table (31).

57. A passive shelving system (100), in particular for a high-bay warehouse, comprising:
a shuttle (1) according to claim 31,
a shelf area (102) with at least two shelves at different vertical positions,
at least two shelf rail sections, which each run along the at least two shelves, wherein the shelf rail sections are designed in such a way that the shuttle (1) can move horizontally on the shelf rail sections, and
at least one passive riser area (101), which connects the shelf rail sections to one another and is designed in such a way that the shuttle (1) can move through the riser area (101) from one shelf rail section to another shelf rail section in a vertical direction.

58. Use of a shuttle (1) according to claim 31 in a passive shelving system (100).
